(19) United States
(12) Patent Application Publication
(10) Pub. No.: US 2008/0219193 A1
(43) Pub. Date: Sep. 11, 2008

(54) WIRELESS NETWORK INTERFACE CARD AND MOBILE WIRELESS MONITORING SYSTEM

(76) Inventors: Min-Tsung TANG, Taoyuan Hsien (TW); Su-Fen Liu, Taoyuan Hsien (TW)

Correspondence Address: BIRCH STEWART KOLASCH & BIRCH, PO BOX 747, FALLS CHURCH, VA, 22040-0747, US

(21) Appl. No.: 12/013,798

(22) Filed: Jan. 14, 2008

(30) Foreign Application Priority Data
Mar. 9, 2007 (TW) 096108096

(51) Int. Cl. H04B 7/00

(52) U.S. Cl. 370/310

(57) ABSTRACT

A wireless network interface card applied with a portable wireless terminal device includes a wireless communication module, a processing module and a connection interface module. The wireless communication module transmits or receives a wireless communication signal having sensing information according to a communication protocol of a personal wireless area network (PWAN). The processing module electrically connected with the wireless communication module receives the sensing information. The connection interface module is electrically connected with the processing module and the portable wireless terminal device. The sensing information is transmitted to the portable wireless terminal device through the processing module and the connection interface module.

### CROSS REFERENCE TO RELATED APPLICATIONS

This Non-provisional application claims priority under 35 U.S.C. §119(a) on Patent Application No(s). 096108096 filed in Taiwan, Republic of China on Mar. 9, 2007, the entire contents of which are hereby incorporated by reference.

### BACKGROUND OF THE INVENTION

1. Field of Invention

The invention relates to a monitoring system and, in particular, to a wireless monitoring system used in conjunction with a wireless network interface card.

2. Related Art

At present, sensor devices have been widely used in the industry. For example, a temperature sensor device can be utilized to monitor the environment temperature, a humidity sensor device can be utilized to monitor the environment humidity and an optical sensor device can be utilized to monitor the environment brightness. Disposing the sensor devices at different positions can construct a sensing system or a monitoring system for monitoring the environment to achieve the objects of early warning problems and enhancing the overall efficiency.

In addition, the progress of the technology also speeds up the development of the wireless communication technology. Therefore, the manufacturers also have designed the sensor devices with the wireless function so that the wireless communication object can be achieved according to the sensor devices in conjunction with wireless communication modules. Referring to FIG. 1, a wireless monitoring system 1 includes a plurality of wireless sensor devices 11 and a server 12, wherein the wireless sensor devices 11 transmit a plurality of pieces of sensing information to the server 12 via wireless signals so that the overall monitoring object can be achieved.

Under this architecture, however, the user cannot monitor the sensing information of each wireless sensor device 11 until the sensing information reaches the server 12. That is, the user can only monitor the information in a fixed manner. In addition, although it is possible to operate the server 12 to achieve the object of remotely controlling each wireless sensor device 11 in the wireless monitoring system 1, this also a fixed remote control method.

To sum up, the wireless monitoring system 1 can only provide the fixed monitoring function and cannot provide the mobile monitoring function. This is inconvenient to the user. More specifically, with regard to the wireless communication technology, such as the Zigbee wireless communication technology, which supports a lot of end devices, the monitoring function provided by the wireless monitoring system 1 further becomes low efficient and slow. In addition, various manufacturers currently develop the associated wireless communication interfaces, so the installation of the wireless communication module is more complicated and the plug-and-play function cannot be achieved in the wireless monitoring system 1.

Therefore, it is an important subject to provide a wireless network interface card and a mobile wireless monitoring system that have the mobile monitoring function and plug-and-play function so that the highly efficient and rapid monitoring processes can be achieved and the overall efficiency can be enhanced.

### SUMMARY OF THE INVENTION

In view of the foregoing, the invention is to provide a wireless network interface card and a mobile wireless monitoring system that have a mobile monitoring function and a plug-and-play function so that the highly efficient and rapid monitoring processes may be achieved and the overall efficiency can be enhanced.

To achieve the above, the invention discloses a wireless network interface card applied with a portable wireless terminal device. The wireless network interface card includes a wireless communication module, a processing module and a connection interface module. The wireless communication module transmits or receives a wireless communication signal having sensing information. The processing module is electrically connected to the wireless communication module and receives the sensing information. The connection interface module is electrically connected to the processing module and the portable wireless terminal device. The sensing information is transmitted to the portable wireless terminal device through the processing module and the connection interface module.

To achieve the above, the invention also discloses a mobile wireless monitoring system, which includes at least one wireless sensor device, a wireless network interface card and a portable wireless terminal device. The wireless sensor device transmits a first wireless communication signal having sensing information. The wireless network interface card has a wireless communication module, a processing module and a connection interface module. The wireless communication module transmits and receives the first wireless communication signal. The processing module, which is electrically connected to the wireless communication module and the connection interface module, receives the sensing information and transmits the sensing information to the connection interface module. The wireless network interface card is electrically connected to the portable wireless terminal device through the connection interface module. The sensing information is transmitted to the portable wireless terminal device through the connection interface module.

As mentioned above, the wireless network interface card is electrically connected to the portable wireless terminal device through the connection interface module according to the invention. When the wireless sensor device sends out its sensing information through the wireless communication signal, the portable wireless terminal device can receive the wireless communication signal through the wireless network interface card, and the wireless network interface card processes the wireless communication signal to obtain the sensing information and transmits the sensing information to the portable wireless terminal device. In addition, the portable wireless terminal device displays the sensing information to achieve the mobile monitoring function with high efficiency and high speed. In addition, the wireless communication signal of the invention is transmitted according to a universal communication protocol, such as the IEEE 802.15.4 protocol, and the wireless network interface card of the invention uses a universal connection interface, such as the SD interface. Thus, the wireless network interface card can be applied with the portable wireless terminal device and become a hot swap element so that the plug-and-play function is achieved and the overall efficiency is enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional wireless monitoring system;

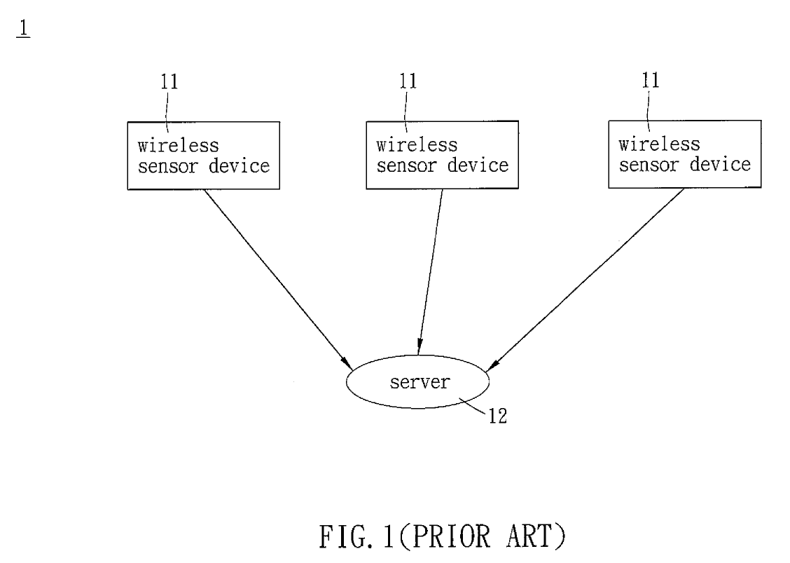

FIG. 2 is a schematic illustration showing a wireless network interface card applied with a portable wireless terminal device according to an embodiment of the invention;

FIG. 3 is a schematic illustration showing the wireless network interface card according to the embodiment of the invention; and

FIG. 4 is a schematic illustration showing a mobile wireless monitoring system according to the embodiment of the invention.

### DETAILED DESCRIPTION OF THE INVENTION

The present invention will be apparent from the following detailed description, which proceeds with reference to the accompanying drawings, wherein the same references relate to the same elements.

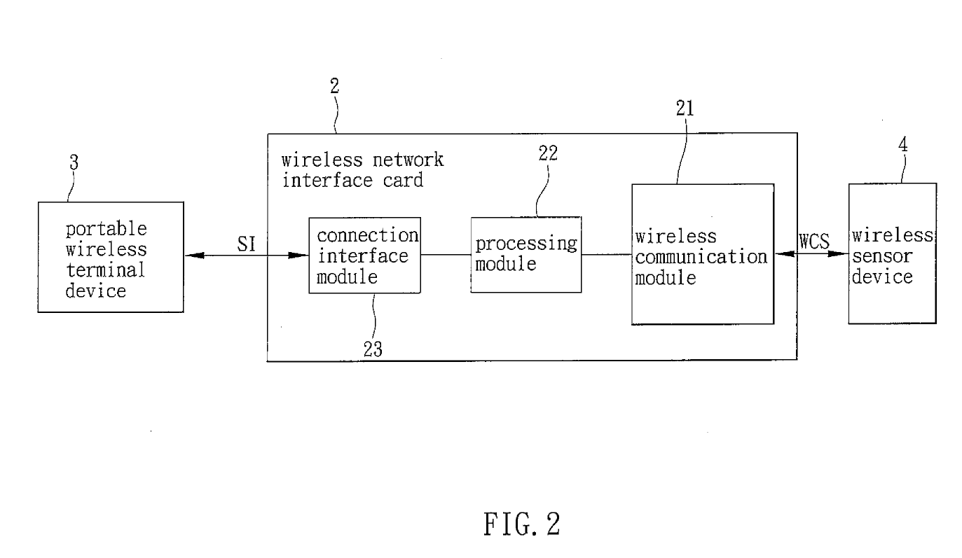

As shown in FIG. 2, a wireless network interface card 2 according to an embodiment of the invention is applied with a portable wireless terminal device 3. The wireless network interface card 2 includes a wireless communication module 21, a processing module 22 and a connection interface module 23. The wireless network interface card 2 can be electrically connected to the portable wireless terminal device 3 through the connection interface module 23.

In this embodiment, the wireless communication module 21 transmits or receives a wireless communication signal WCS according to a communication protocol of a wireless personal area network (WPAN). Herein, the wireless communication module 21 can be implemented by a base band circuit and a radio frequency (RF) circuit. The base band circuit is mainly in charge of connection establishing/removing and signal encoding, while the radio frequency circuit is mainly in charge of carrier synthesizing and signal receiving/transmitting.

The wireless communication signal WCS of this embodiment can satisfy the IEEE 802.15.4 protocol, which is specified in the Zigbee wireless communication technology and is adapted to an electronic device with low data rate and low power consumption. In addition, the Zigbee wireless communication technology utilizes the scheme of carries sense multiple access with collision avoidance (CSMA-CA), so it has the features of resisting the signal interference and high signal stability.

In this embodiment, the wireless communication signal WCS is transmitted from a wireless sensor device 4. When the wireless sensor device 4 receives a sensing information, the sensing information is transmitted out through the wireless communication signal WCS. The sensing information can be selected from the group consisting of temperature sensing information, humidity sensing information and light sensing information.

The processing module 22 is electrically connected to the wireless communication module 21 and the connection interface module 23. When the wireless communication module 21 receives the wireless communication signal WCS, it decodes the wireless communication signal WCS to obtain the sensing information and transmits the sensing information to the processing module 22. Then, the processing module 22 transmits the sensing information to the connection interface module 23. In this embodiment, the wireless communication module 21 and the processing module 22 can be implemented in one single chip. In addition, the processing module 22 of this embodiment further has a transmission interface (not shown), which is connected and communicated with other peripheral circuits (e.g., the connection interface module 23). The transmission interface can be a universal asynchronous receiver/transmitter (UART).

In addition, the connection interface module 23 is electrically connected to the processing module 22 and the portable wireless terminal device 3. The sensing information SI is transmitted to the portable wireless terminal device 3 through the connection interface module 23. In this embodiment, the portable wireless terminal device 3 can be a personal digital assistant (PDA), a mobile phone or a notebook computer. The portable wireless terminal device 3 can receive the sensing information SI and display the sensing information SI on a display, so that a user can watch the information on the display so as to obtain the mobile monitoring function.

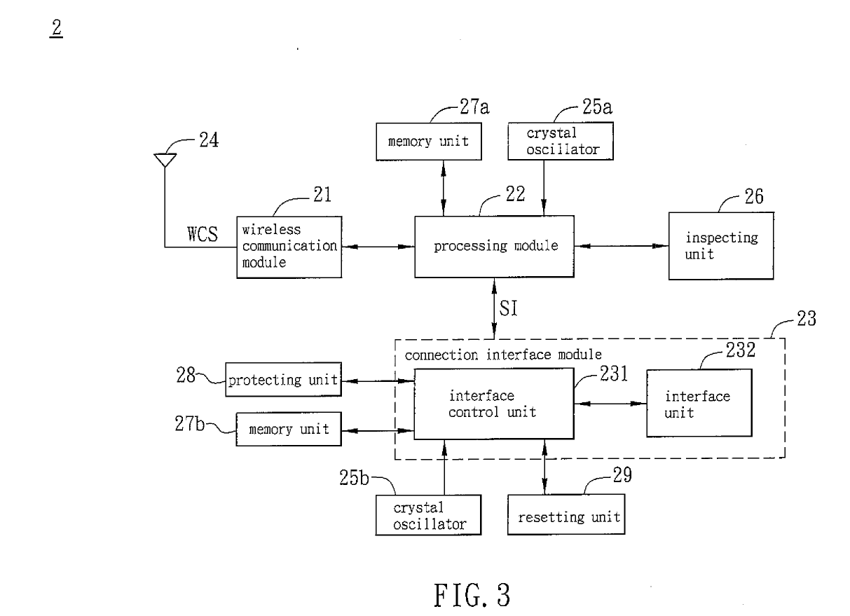

The wireless network interface card 2 of this embodiment will be further described with reference to FIG. 3.

In this embodiment, the wireless network interface card 2 further includes at least one antenna 24, which is electrically connected to the wireless communication module 21 and transmits or receives the wireless communication signal WCS having an electromagnetic waveform. The antenna 24 can be a printed antenna so that the cost can be decreased. The wireless network interface card 2 further includes a crystal oscillator 25a, which is electrically connected to the processing module 22 for providing a clock signal. In addition, the wireless network interface card 2 further includes an inspecting unit 26, which can be electrically connected to the processing module 22 for detecting an operating state of the processing module 22 so that it is obtained whether the wireless network interface card 2 is in an operating state for transmitting or receiving (Tx/Rx), for example. The inspecting unit 26 can be implemented by an XOR gate or a digital logic gate that implements exclusive disjunctions. In addition, the wireless network interface card 2 can further include a memory unit 27a for storing data. Herein, the memory unit 27a can be a flash memory.

The connection interface module 23 has an interface control unit 231 and an interface unit 232. The interface control unit 231 is electrically connected to the interface unit 232 and the processing module 22, while the interface unit 232 is electrically connected to the portable wireless terminal device 3. The sensing information SI is converted, by the interface control unit 231, into converted information having the specification of the interface unit 232, and the converted information is transmitted to the portable wireless terminal device 3 through the interface unit 232. In this embodiment, the interface unit 232 is, for example but not limited to, a SD interface, a CF interface, a USB interface or an RS-232 interface.

The wireless network interface card 2 further includes a protecting unit 28, which is electrically connected to the interface control unit 231 and protects a pin or pins of the interface unit 232 to avoid the surge from influencing other circuits. The wireless network interface card 2 further includes another crystal oscillator 25b, which is electrically connected to the interface control unit 231 for providing a clock signal. The wireless network interface card 2 further includes a reset unit 29, which is electrically connected to the interface control unit 231 for resetting the interface control unit 231. In addition, the wireless network interface card 2 can further include another memory unit 27b for storing data. Herein, the memory unit 27b can be an electrically erasable programmable read only memory (EEPROM).

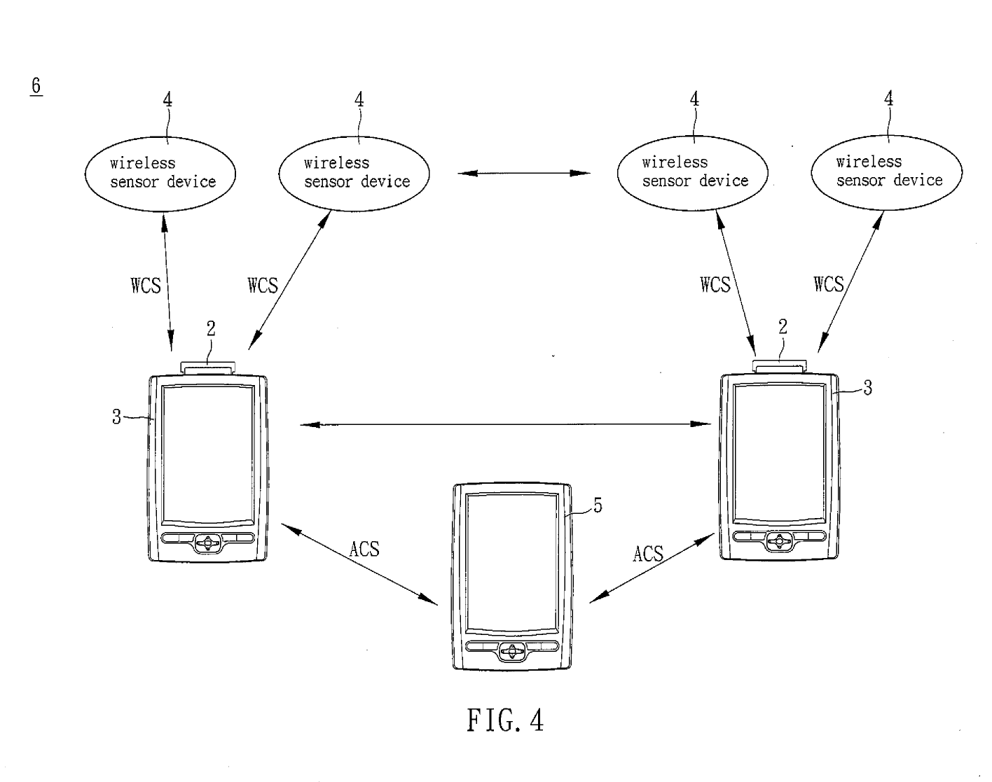

Referring to FIG. 4, a mobile monitoring system 6 according to the embodiment of the invention includes at least one wireless sensor device 4, at least one wireless network interface card 2, at least one portable wireless terminal device 3 and one wireless terminal device 5. The wireless sensor device 4, the wireless network interface card 2 and the portable wireless terminal device 3 have been described hereinabove, so detailed descriptions thereof will be omitted.

In this embodiment, the user inserts the wireless network interface cards 2 into the corresponding portable wireless terminal devices 3 respectively so that the wireless network interface cards 2 can be applied with the portable wireless terminal devices 3. Therefore, the wireless network interface card 2 has the plug-and-play efficiency in practice.

When the wireless sensor devices 4 receive one piece or multiple pieces of sensing information through its sensing member, the sensing information is transmitted out via the wireless communication signal WCS, and the portable wireless terminal devices 3 receive the wireless communication signals WCS through the wireless network interface cards 2. In addition, the wireless network interface cards 2 process the wireless communication signals WCS to obtain the sensing information, and transmit the sensing information to the portable wireless terminal devices 3. Thus, the user can monitor the sensing information through the portable wireless terminal devices 3 so that the mobile monitoring function is obtained.

Furthermore, the portable wireless terminal devices 3 can communicate with each other and transmit the sensing information, or transmit the sensing information to the wireless terminal device 5 through another wireless communication signal ACS. Herein, the wireless network interface card 2 does not have to be inserted into the wireless terminal device 5. In addition, the wireless communication signal ACS can satisfy the specification of any wireless area network, such as the IEEE 802.11 specification, which currently includes IEEE 802.11a/b/g/n, and the likes. Consequently, the range that can be monitored by the mobile monitoring system 6 can be expanded so that the overall efficiency is enhanced.

It is to be noted that the wireless network interface card 2 of this embodiment can also be applied with the electronic device having the sensing member so that a wireless sensor device is formed. In this embodiment, for example, if the portable wireless terminal device 3 has the sensing member, the portable wireless terminal device 3 can also become the wireless sensor device through the wireless network interface card 2. This also shows that the wireless network interface card 2 of this embodiment has the widely extendable, expandable and applicable properties.

In summary, the wireless network interface card is electrically connected to the portable wireless terminal device through the connection interface module according to the concept of the invention. When the wireless sensor device sends out its sensing information through the wireless communication signal, the portable wireless terminal device can receive the wireless communication signal through the wireless network interface card, and the wireless network interface card processes the wireless communication signal to obtain the sensing information and transmits the sensing information to the portable wireless terminal device. In addition, the portable wireless terminal device displays the sensing information to achieve the mobile monitoring function with high efficiency and high speed. In addition, the wireless communication signal of the invention is transmitted according to a universal communication protocol, such as the IEEE 802.15.4 protocol, and the wireless network interface card of the invention uses a universal connection interface, such as the SD interface. Thus, the wireless network interface card can be applied with the portable wireless terminal device and become a hot swap element so that the plug-and-play function is achieved and the overall efficiency is enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wireless network interface card applied with a portable wireless terminal device, comprising:
a wireless communication module transmitting or receiving a wireless communication signal having a sensing information;
a processing module electrically connected to the wireless communication module for receiving the sensing information; and
a connection interface module electrically connected to the processing module and the portable wireless terminal device, wherein the sensing information is transmitted to the portable wireless terminal device through the processing module and the connection interface module.

2. The wireless network interface card according to claim 1, wherein the wireless communication module transmits or receives the wireless communication signal according to a communication protocol of a personal wireless area network (PWAN).

3. The wireless network interface card according to claim 2, wherein the communication protocol is an IEEE 802.15.4 protocol.

4. The wireless network interface card according to claim 1, further comprising at least one antenna electrically connected to the wireless communication module for transmitting or receiving the wireless communication signal having an electromagnetic waveform.

5. The wireless network interface card according to claim 1, further comprising a crystal oscillator electrically connected to the processing module for providing a clock signal.

6. The wireless network interface card according to claim 1 further comprising:
an inspecting unit electrically connected to the processing module for detecting an operating state of the processing module, wherein the inspecting unit comprises a digital logic gate that implements exclusive disjunction or an XOR gate.

7. The wireless network interface card according to claim 1, further comprising a memory unit electrically connected to the processing module for storing data.

8. The wireless network interface card according to claim 1, wherein the connection interface module comprises:
an interface unit electrically connected to the portable wireless terminal device; and
an interface control unit electrically connected to the interface unit and the processing module, wherein the sensing information is converted by the interface control unit into converted information having a specification of the interface unit, and the converted information is transmitted to the portable wireless terminal device through the interface unit.

9. The wireless network interface card according to claim 8, further comprising a protecting unit electrically connected to the interface control unit for protecting a pin of the interface unit.

10. The wireless network interface card according to claim 8, further comprising:
a crystal oscillator electrically connected to the interface control unit for providing a clock signal.

11. The wireless network interface card according to claim 8, further comprising a resetting unit electrically connected to the interface control unit for resetting the interface control unit.

12. The wireless network interface card according to claim 8, wherein the interface unit is an SD interface, a CF interface, a USB interface or an RS-232 interface.

13. The wireless network interface card according to claim 8, further comprising a memory unit electrically connected to the interface control unit for storing data.

14. The wireless network interface card according to claim 1, wherein the wireless communication module comprises a base band circuit and a radio frequency circuit, the base band circuit is in charge of connection establishing/removing and signal encoding, and the radio frequency circuit is in charge of carrier synthesizing and signal receiving/transmitting.

15. The wireless network interface card according to claim 1, wherein the wireless communication module and the processing module are implemented in one single chip.

16. The wireless network interface card according to claim 1, wherein the processing module further comprises a transmission interface connecting and communicating with the connection interface module.

17. The wireless network interface card according to claim 1, wherein the portable wireless terminal device is capable of transmitting the sensing information to another wireless terminal device through another wireless communication signal, and the wireless communication signal satisfies an IEEE 802.11 specification or standard.

18. A mobile wireless monitoring system comprising:
at least one wireless sensor device for transmitting a first wireless communication signal having a sensing information;
a wireless network interface card having a wireless communication module, a processing module and a connection interface module, wherein the wireless communication module transmits and receives the first wireless communication signal, and the processing module is electrically connected to the wireless communication module and the connection interface module for receiving the sensing information and transmitting the sensing information to the connection interface module; and
a portable wireless terminal device, wherein the wireless network interface card is electrically connected to the portable wireless terminal device through the connection interface module, and the sensing information is transmitted to the portable wireless terminal device through the connection interface module.

19. The mobile wireless monitoring system according to claim 18, wherein the wireless sensor device transmits the first wireless communication signal according to a communication protocol of a personal wireless area network (PWAN), and the communication protocol is an IEEE 802.15.4 protocol.

20. The mobile wireless monitoring system according to claim 18, wherein the connection interface module is a SD interface, a CF interface, a USB interface or an RS-232 interface.

21. The mobile wireless monitoring system according to claim 18, wherein the sensing information is a temperature sensing information, humidity sensing information or light sensing information.

22. The mobile wireless monitoring system according to claim 18, wherein the portable wireless terminal device transmits the sensing information to a wireless terminal device through a second wireless communication signal.

23. The mobile wireless monitoring system according to claim 22, wherein the second wireless communication signal satisfies an IEEE 802.11 specification or standard.

24. The mobile wireless monitoring system according to claim 18, wherein the portable wireless terminal device is a personal digital assistant (PDA), a mobile phone or a notebook computer.
